(19) United States
(12) Patent Application Publication
(10) Pub. No.: US 2012/0060664 A1
(43) Pub. Date: Mar. 15, 2012

(54) Microtome Having Means for Reversing a Direction of Rotation

(75) Inventor: Jiuhu HA, Shanghai (CN)

(73) Assignee: LEICA MICROSYSTEMS LTD. SHANGHAI, Shanghai (CN)

(21) Appl. No.: 13/227,705

(22) Filed: Sep. 8, 2011

(30) Foreign Application Priority Data
Sep. 14, 2010 (CN) 201010537326.X

(51) Int. Cl. G01N 1/06; B26D 5/10

(52) U.S. Cl. 83/591

(57) ABSTRACT

The present invention relates to a microtome (10) including a first shaft (12) which is arranged in a fixed position and capable of being driven by a handwheel and which has a first gear wheel (14) non-rotatably mounted thereon. The microtome (10) further includes a second shaft (16) which is arranged in a fixed position and has a second gear wheel (18) non-rotatably mounted thereon. The first gear wheel (14) and the second gear wheel (18) are coupled to each other via a transmission unit (20), so that the second shaft (16) can be driven by the first shaft (12). In a first position of the transmission unit (20), the two shafts (12, 16) are rotatable in the same direction, while in a second transmission position, they are rotatable in opposite directions.

### CROSS REFERENCE TO RELATED APPLICATIONS

This application claims priority of Chinese patent application number 201010537326.X filed Sep. 14, 2010, the entire disclosure of which is incorporated by reference herein.

### FIELD OF THE INVENTION

The present invention relates to a microtome which is manually drivable with the aid of at least one handwheel to cut thin sections.

### BACKGROUND OF THE INVENTION

In known rotary microtomes, the cutting unit is driven by turning a handwheel. The rotary microtome includes in particular two handwheels, a first handwheel being used for coarse feeding of the sample to be sectioned toward a cutting element of the cutting unit, and a second being used for producing the sample movement for cutting the sample. There are users who find it more comfortable to turn the first handwheel clockwise, while other users find it comfortable to turn the first handwheel counterclockwise. Therefore, there are commercially available microtomes in which in order to effect coarse feeding, the first handwheel has to be rotated clockwise, as well as microtomes in which the first handwheel has to be rotated counterclockwise. The user must choose one of the two variants at the time of purchase. The direction of rotation required for coarse feeding can later be changed only by a technician making extensive and complex modifications to the microtome.

German Patent Document DE 10 2006 031 136 B3 describes a crank drive system of a shaft of a microtome, where a manually drivable first shaft has a first transfer means. A second shaft has a second and a third transfer means, the shaft being movable in an axial direction so that either the second or the third transfer means meshes with the first transfer means. Depending on whether the second or third transfer means is in meshing engagement with the first transfer means, the second shaft is rotated in the same direction as the first shaft or in the opposite direction. This crank drive system has the problem that in order to change the direction of rotation, the second shaft has to be moved axially together with the transfer means mounted thereon. It is also problematic that the crank drive system is complex and requires a considerable amount of space.

### SUMMARY OF THE INVENTION

It is an object of the present invention to provide a microtome that is easy and comfortable to use. This object is achieved by a microtome having the features described herein.

In accordance with the present invention, a first gear wheel non-rotatably connected to the first shaft is coupled via a transmission unit to a second gear wheel non-rotatably connected to a second shaft by a transmission unit. Both the first and the second shafts, as well as the gear wheels mounted thereon, are arranged in a fixed position. When the transmission unit is in a first position, the two shafts are rotatable in the same direction, while in a second transmission position, they are rotatable in opposite directions. The second shaft serves, in particular, for driving a cutting unit. Rotation of the second shaft in a preselected direction enables coarse feeding of the sample to be cut toward a cutting element, in particular a cutting knife, of the cutting unit and/or enables producing the cutting motion needed to cut the sample. The cutting motion includes, in particular, an upward and a downward movement of the sample, as well as a feed movement for feeding the sample toward the cutting element.

By providing the transmission unit, the direction in which the handwheel has to be rotated in order to cut the thin sections can be easily adapted to the preferences of an individual user by shifting the transmission unit between its two positions. Thus, one and the same microtome can be used by several users, and the handwheel for cutting the thin sections can be operated by each user according to his or her personal preferences.

Since a transmission unit is interposed between the first and the second shafts, neither the first nor the second shaft, or any elements mounted thereon, need to be moved in order to change the direction of rotation, but may be arranged in a fixed position. In this manner, a simple and compact design is achieved.

In a preferred embodiment of the present invention, when the transmission unit is in the first position, the first and second gear wheels are coupled to each other by an odd number of idler gears, while in the second transmission position, they are coupled by an even number of idler gears. When coupling is via an odd number of idler gears, the two shafts rotate in the same direction, while when coupling is via an even number of idler gears, the two shafts rotate in opposite directions.

In another preferred embodiment of the present invention, when the transmission unit is in the first position, the first gear wheel is coupled to the second gear wheel by a first idler gear, while in the second transmission position, it is coupled to the second gear wheel by a second and third idler gears. As a result of this, only three idler gears are needed for the transmission unit, so that the reversal of the direction of rotation can be achieved with a minimum number of idler gears, thus allowing for a compact design. When the transmission unit is in the first position, the first gear wheel is in meshing engagement with the first idler gear, and the first idler gear in turn is in meshing engagement with the second gear wheel. When the transmission unit is in the first position, neither the first nor the second gear wheel contacts the second and/or the third idler gear. When the transmission unit is in the second position, the first gear wheel is in meshing engagement with the second idler gear, the second idler gear is in meshing engagement with the third idler gear, and the idler gear in turn is meshing engagement with the second gear wheel. In the second transmission position, neither the first nor the second gear wheel contacts the first idler gear.

The first idler gear has, in particular, a greater diameter than the second and third idler gears, so that when the transmission unit is in the first position, the fixed distance between the first and second gear wheels can be bridged by the first idler gear alone, without requiring any additional transfer elements.

The second idler gear and the third idler gear are preferably arranged at an angle to the first idler gear and/or to the first and second gear wheels, thereby achieving a very compact design for the transmission unit. In an alternative embodiment of the present invention, the gear wheels and the idler gears may also be arranged in one plane.

The idler gears are, in particular, arranged in a fixed position relative to each other, forming an idler gear assembly which can be moved as a unit relative to the first gear wheel and the second gear wheel. Because of this, the transmission unit can be shifted between its two positions by moving the idler gear assembly accordingly. It is particularly advantageous if this movement is translational, so that shifting of the transmission between its positions can be accomplished by performing as simple a movement as possible.

The microtome includes, in particular, a shifting unit allowing the transmission unit to be shifted manually between its first and second positions. The shifting unit, in turn, preferably has a manually operable actuating element, at least a portion of which is located outside of a housing of the microtome. Thus, the direction of rotation of the handwheel required for coarse feeding of the sample and/or for sectioning can be easily selected by the user of the microtome. There is no need for a technician to open the housing in order to change the direction of rotation. The actual transmission unit, and the first and second gear wheels, are preferably disposed within the housing of the microtome and thereby protected by the housing.

The shifting unit includes, in particular, an eccentric which converts a rotational movement of the actuating element into a translational movement for translationally shifting the transmission unit. This allows easy shifting between the two transmission positions. When the transmission unit is in its first or second position, the eccentric engages with latching elements, causing the transmission unit to be retained in the respective position and preventing unintentional shifting between the transmission positions.

The transmission unit may be retained in the first position by a resilient element. In this case, the transmission unit is movable from its first position to its second position against a restoring force of the resilient element. In an alternative embodiment of the present invention, the transmission unit may be retained in the second transmission position by the resilient element. The resilient element is, in particular, in the form of a compression spring.

The microtome is, in particular, a rotary microtome which preferably includes a first handwheel for coarse feeding of the sample and a second handwheel for producing the cutting motion. The handwheel mounted on the first shaft can be both the first handwheel and the second handwheel.

Further features and advantages of the present invention will become apparent from the following description of exemplary embodiments thereof taken in conjunction with the accompanying drawings, in which:

### BRIEF DESCRIPTION OF THE DRAWINGS

FIG. 1 is a schematic perspective view of a detail of a microtome;

FIG. 2 is a side view of the detail of the microtome shown in FIG. 1; and

FIG. 3 is a cross-sectional view of the detail of the microtome shown in FIGS. 1 and 2, taken along section A-A of FIG. 2.

### DETAILED DESCRIPTION OF THE INVENTION

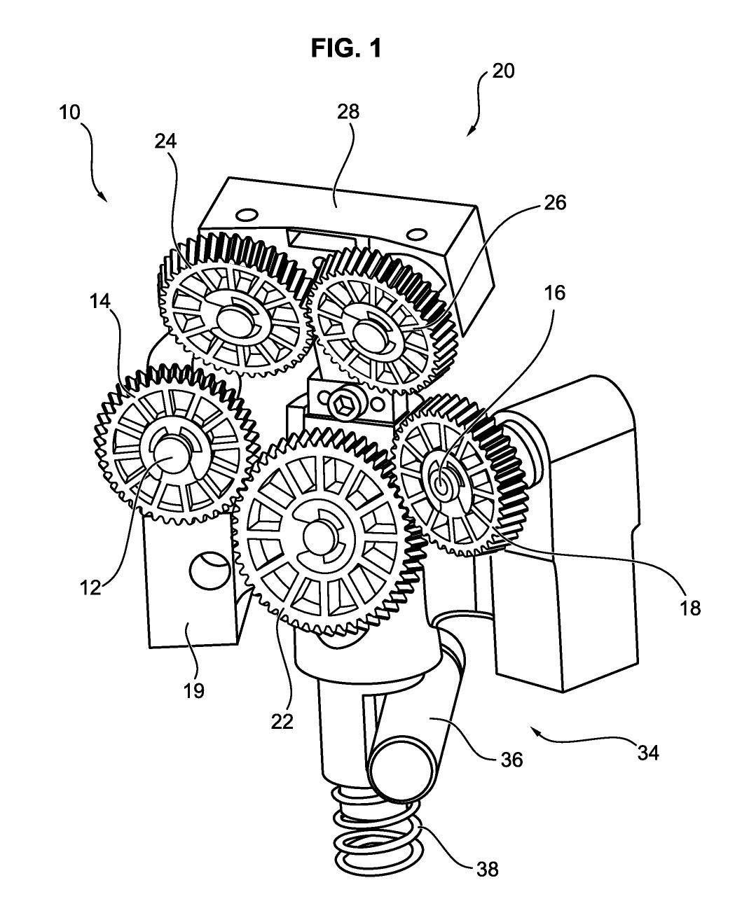

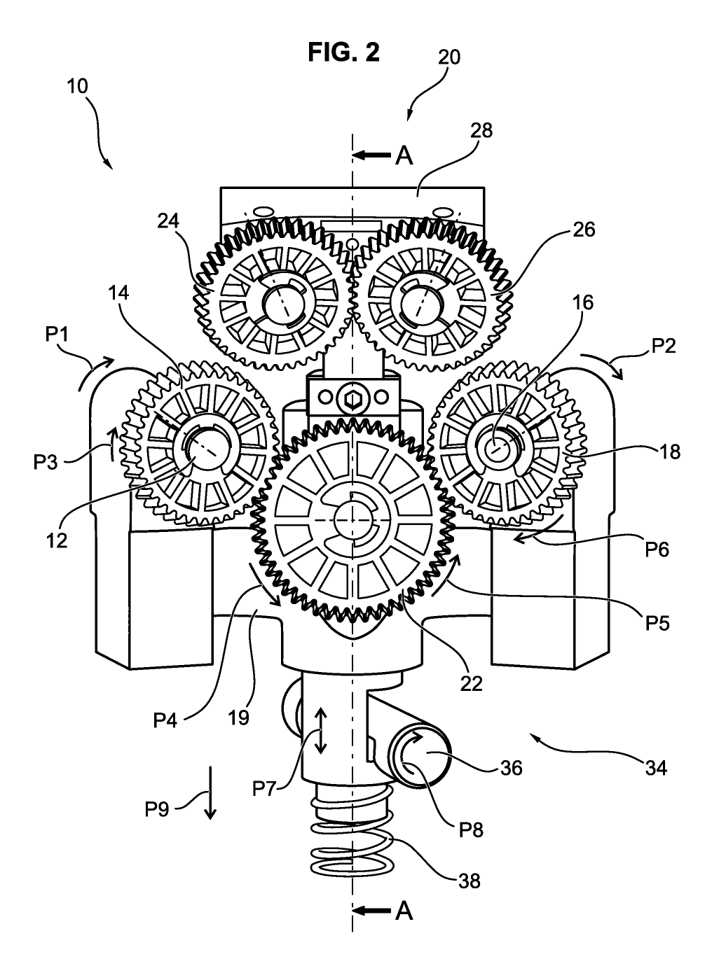

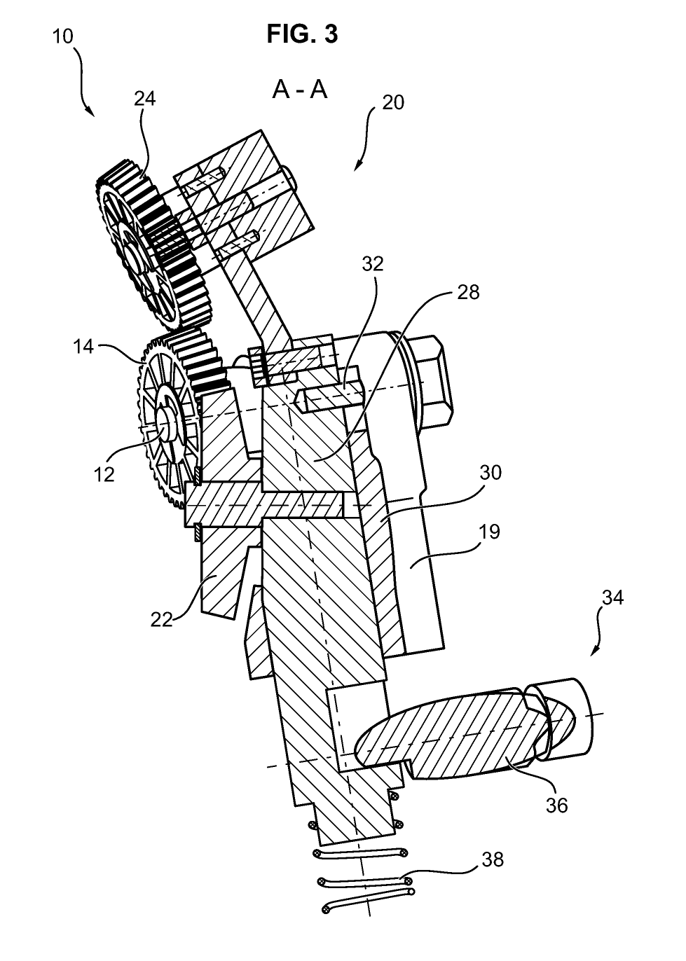

Referring to FIG. 1, there is shown a detail of a microtome 10 in a schematic perspective view. FIG. 2 shows this microtome in a side view, and FIG. 3 is a cross-sectional view along section A-A in FIG. 2.

Microtome 10 includes a first shaft 12 having a first gear wheel 14 non-rotatably connected thereto at one end thereof. Shaft 12 is drivable by a handwheel not shown in FIGS. 1 through 3. This handwheel may be both a handwheel for producing the cutting motion needed to cut the samples, and a handwheel for coarse feeding of the sample, which, when turned in a preselected direction, causes the sample mounted for sectioning in microtome 10 to be transported into proximity with a cutting element of a cutting unit for producing thin sections. The cutting motion includes, in particular, an upward and a downward movement of the sample along the cutting element for cutting thin sections from the sample, and further includes a feed movement for moving the sample toward the cutting element between each two cutting operations.

Further, microtome 10 includes a second shaft 16 which in turn has a second gear wheel 18 non-rotatably mounted thereon at one end thereof. Second shaft 16 is accordingly used to effect coarse feeding and/or to produce the cutting motion. The cutting unit is not shown in FIGS. 1 through 3. Shafts 12, 16 are mounted in a first bearing unit 19 arranged in a fixed position relative to the housing of microtome 10, so that the two shafts 12, 16 and the gear wheels 14, 18 mounted thereon are arranged in a fixed position.

Gear wheels 14, 18 can be coupled to each other via a transmission unit 20, so that second shaft 16 can be driven by first shaft 12. This allows second shaft 16 to be driven by the handwheel, so that the motion required for cutting the thin sections can be produced by rotating the handwheel.

Transmission unit 20 is shiftable between a first transmission position and a second transmission position. In FIGS. 1 through 3, transmission unit 20 is shown in its first position. Transmission unit 20 includes three idler gears 22, 24, and 26. When the transmission unit is in the first position, first idler gear 22 is in meshing engagement with both first gear wheel 14 and second gear wheel 18, so that the two gear wheels 14, 18 are coupled to each other via first idler gear 22.

When first shaft 12 is rotated as indicated by arrow P1 in FIG. 2, first gear wheel 14 is rotated in the same direction, as indicated by arrow P3. First idler gear 22 rotated in a direction opposite to that of first shaft 12, as indicated by arrows P4 and P5. First idler gear 22 in turn drives second gear wheel 18 in the direction of arrow P6, and thus in the same direction of rotation as first shaft 12. Since second gear wheel 18 is non-rotatably connected to second shaft 16, said second shaft is rotated in the direction of arrow P2. Accordingly, first shaft 12 and second shaft 16 are driven in the same direction of rotation.

When first shaft 12 is rotated in a direction opposite to arrow P1, second shaft 16 is also rotated in a direction opposite to arrow P2 when transmission unit 20 is in the first position. Again, first shaft 12 and second shaft 16 are driven in the same direction of rotation.

The three idler gears 22, 24, and 26 are rotatably mounted in a fixed position in a second bearing unit 28. Second bearing unit 28 and the idler gears 22, 24, and 26 mounted thereto can be translationally shifted in the direction of double-headed arrow P7 relative to first bearing unit 19, and thus relative to shafts 12, 16 and gear wheels 14, 18. To this end, second bearing unit 28 is axially movably supported in a guide element 30 of first bearing unit 19. A securing element 32 prevents second bearing unit 28, and thus idler gears 22, 24, and 26, from rotating out of position, thereby reliably ensuring that idler gears 22, 24, and 26 are in meshing engagement with gear wheels 14, 18 both when transmission unit 20 is in the first position and when it is in the second position.

Also provided is a shifting unit 34, which allows transmission unit 20 to be axially translationally moved in the direction of double-headed arrow P7 for shifting the transmission between its positions. Transmission unit 20 includes, in particular, an actuating element (not shown), at least a portion of which is located outside of the housing of microtome 10, and which therefore can be easily operated by a user. The actuating element is connected to an eccentric 36, with the aid of which a rotational movement caused by a user for shifting transmission unit 20 as indicated by arrow P8 is converted into a translational movement. Thus, by suitably operating the actuating element and rotating eccentric 36 in order to shift transmission unit 20 from its first position shown FIGS. 1 through 3 to its second position, the transmission unit is moved in the direction of arrow P9 until first idler gear 22 is no longer in contact with gear wheels 14, 18 and second idler gear 24 and third idler gear 26 are in meshing engagement with gear wheels 14, 18.

A compression spring 38 holds transmission unit 20 in its first position. In order to shift transmission unit 20 from its first to its second position, transmission unit 20 is moved against the force of compression spring 38 in the direction of arrow P9. Eccentric 36 is configured, in particular, in such a manner that when it assumes one of its end positions, where transmission unit 20 is in its first position or its second position, it engages with corresponding latching means and is thereby locked in position. This prevents transmission unit 20 from being unintentionally shifted from one position to the other.

In the second transmission position, first gear wheel 14 is in meshing engagement with second idler gear 24, which in turn is in meshing engagement with third idler gear 26. Third idler gear 26 is in meshing engagement with second gear wheel 18. As a result of this, second idler gear 24 is rotated in a direction opposite to that of first gear wheel 14, third idler gear 26 in turn is rotated in the same direction as first gear wheel 14, and second gear wheel 18 is rotated in a direction opposite to that of first gear wheel 14. Consequently, shafts 12, 16 are rotated in opposite directions when the transmission unit is in its second position.

The shifting of transmission unit 20 provides an easy way to select the direction in which first shaft 12, and thus also the handwheel firmly connected thereto, must be rotated in order to rotate second shaft 16 in a preselected direction which is required to effect coarse feeding of the sample and/or to cut the sample to be sectioned by means of the cutting unit. Thus, the direction of rotation of the handwheel can be selected by any user in accordance with what he or she feels to be more comfortable, so that microtome 10 can be used by several users, and the handwheel for coarse feeding and/or sectioning of the sample can be rotated by each user in his or her preferred direction.

As is apparent in FIG. 3, idler gears 22, 24, and 26 are not in one plane. Rather, idler gears 24, 26 are arranged at an angle to first idler gear 22. Similarly, gear wheels 14, 18 are arranged at an angle to both first idler gear 22 and idler gears 24, 26, so that the five gears 14, 18, 22 through 26 form an approximately dish-shaped assembly, which allows for a very compact design.

Although the present invention has been described with respect to one or more particular embodiments, it will be understood that other embodiments of the present invention may be made without departing from the spirit and scope of the present invention.

### LIST OF REFERENCE NUMERALS

10 microtome

12, 16 shafts

14, 18 gear wheel

19, 28 bearing unit

20 transmission unit

22 through 26 idler gear

30 guide element

32 securing element

34 shifting unit

36 eccentric

38 compression spring

P1 through P9 direction

What is claimed is:

1. A microtome comprising:
a first shaft (12) which is arranged in a fixed position and capable of being driven by a handwheel;
a first gear wheel (14) non-rotatably mounted on the first shaft;
a second shaft (16) arranged in another fixed position;
a second gear wheel (18) non-rotatably mounted on the second shaft; and
a transmission unit (20) via which the first gear wheel (14) and the second gear wheel (18) are coupled to each other so that the second shaft (16) can be driven by the first shaft (12);
wherein the first shaft (12) and the second shaft (16) are rotatable in the same direction when the transmission unit (20) is in a first position; and
wherein the first shaft (12) and the second shaft (16) are rotatable in opposite directions when the transmission unit (20) is in a second position.

2. The microtome (10) as recited in claim 1, wherein when the transmission unit is in the first position, the first gear wheel (14) and the second gear wheel (18) are coupled to each other by an odd number of idler gears (22 through 26);
wherein when the transmission unit is in the second transmission position, the first gear wheel (14) and the second gear wheel (18) are coupled by an even number of idler gears (22 through 26).

3. The microtome (10) as recited in claim 1, wherein when the transmission unit is in the first position, the first gear wheel (14) is coupled to the second gear wheel (18) by a first idler gear (22), the first gear wheel (14) being in meshing engagement with the first idler gear (22), and the first idler gear (22) being in meshing engagement with the second gear wheel (18);
wherein when the transmission unit is in the second position, the first gear wheel (14) is coupled to the second gear wheel (18) by a second idler gear (24) and a third idler gear (26), the first gear wheel (14) being in meshing engagement with the second idler gear (24), the second idler gear (24) being in meshing engagement with the third idler gear (26), and the third idler gear (26) being in meshing engagement with the second gear wheel (18).

4. The microtome (10) as recited in claim 3, wherein the first idler gear (22) has a greater diameter than the second idler gear (24) and the third idler gear (26).

5. The microtome (10) as recited in claim 3, wherein the second idler gear (24) and the third idler gear (26) are arranged at an angle to the first idler gear (22) and/or to the first and second gear wheels (14, 18).

6. The microtome (10) as recited in claim 2, wherein the idler gears (22 through 26) are arranged in a fixed position relative to each other on a bearing unit (28); and
wherein the bearing unit (28) is movable relative to the first gear wheel (14) and the second gear wheel (18).

7. The microtome (10) as recited in claim 1, wherein the transmission unit (20) can be shifted manually between its first and second positions by means of a shifting unit (34).

8. The microtome (10) as recited in claim 7, wherein the microtome (10) includes a housing;
wherein the shifting unit (34) includes a manually operable actuating element, at least a portion of which is located outside of the housing.

9. The microtome (10) as recited in claim 7, wherein the shifting unit (34) includes an eccentric (36) for translationally shifting the transmission unit (20).

10. The microtome (10) as recited in claim 1, wherein the transmission unit (20) is retained in the first position by a resilient element (38), in particular a compression spring; and
wherein the transmission unit (20) is movable from its first position to its second position against a restoring force of the resilient element (38).

11. The microtome (10) as recited in claim 1, wherein the microtome (10) is a rotary microtome.
